(19) United States
(12) Patent Application Publication
(10) Pub. No.: US 2026/0265523 A1
(43) Pub. Date: Sep. 10, 2026

(54) ETHYLENE/ALPHA-OLEFIN INTERPOLYMER BASED COMPOSITIONS WITH PARTIALLY HYDROGENATED ROSIN ESTERS

(71) Applicant: Dow Global Technologies LLC, Midland, MI (US)

(72) Inventors: Allan Walter McLennaghan, Tarragona (ES); Wanfu Ma, Shanghai (CN); Juan C. Tuberquia, Pearland, TX (US)

(21) Appl. No.: 19/165,869

(22) PCT Filed: Aug. 31, 2023
(86) PCT No.: PCT/CN2023/116140

§ 371 Date: Sep. 16, 2025

(51) Int. Cl. C08L 93/04; C08K 5/134; C09J 193/04

(52) U.S. Cl. CPC C08L 93/04; C09J 193/04; C08K 5/134; C08L 2205/025; C08L 2205/03; C08L 2207/322

(57) ABSTRACT

A composition comprising at least the following components: a) an ethylene/alpha-olefin interpolymer that comprises the following properties: i) a melt index (I2)≤10 dg/min, ii) a density from 0.855 to 0.895 g/cc; b) a partially hydrogenated rosin ester tackifier(s).

### BACKGROUND OF THE INVENTION

Hot melt adhesives are generally formulated compositions based on blends of a polymer and a tackifying resin. The polymer and tackifying resin are carefully selected in order to form a high performing hot melt adhesive (HMA). There is a need for adhesive compositions that have improved adhesion performance in hygiene applications, and that contain tackifiers derive from natural, renewable resources.

International Publication WO2019/037039 discloses a composition comprising the following: (A) an ethylene-based interpolymer having (i) a density from 0.860 g/cc to 0.900 g/cc; and (ii) a melt viscosity, at 177° C., less than, or equal to, 50,000 mPa·s; and (B) a rosin ester containing the following: (i) greater than, or equal to, 75 mol % aliphatic carbon, based on total moles of carbon in the rosin ester; and (ii) less than, or equal to, 3.0 mol % ester group carbon, based on total moles of carbon in the rosin ester (see abstract). Rosin esters are described on pages 8-13.

U.S. Pat. No. 7,199,180 discloses adhesive compositions comprising at least one homogeneous ethylene/alpha-olefin interpolymer and a tackifier. This reference discloses, in general, several types of tackifiers, including rosin and rosin esters (see column 15, lines 43-49; column 46, lines 14-18 (hydrogenated rosin esters)). In particular, this reference discloses the following rosin esters FLORAL 105, a pentaerythritol ester of a hydrogenated rosin (see column 30, lines 13-15; column 33, Table 5; column 35, lines 1-2, and 15-17) and SYLVATAC 1103, a rosin ester (see column 38, Table 8A; column 53, Table 18C).

U.S. Pat. No. 6,582,829 discloses a hot melt adhesive composition comprising: a) from about 5 wt % to about 50 wt % of at least one homogeneous linear or substantially linear ethylene/alpha-olefin interpolymer, characterized as having a density from 0.850 to 0.965 g/cm; b) from about 1 wt % to about 40 wt % of at least one block copolymer; and c) from about 10 wt % to about 75 wt % of at least one tackifying resin (see abstract). This reference discloses, in general, several types of tackifiers, including rosin and rosin esters (see column 7, line 64, to column 8, line 2).

U.S. Pat. No. 9,115,299 discloses a low application temperature, hot melt adhesive comprising olefin copolymers with an average melt index greater than 5, but less than about 35 g/10 minutes, at 190° C. (see abstract). The adhesive is disclosed as useful in construction of nonwoven articles (see abstract). This reference discloses, in general, several types of tackifiers, including hydrogenated and nonhydrogenated rosin and rosin esters (see column 6, lines 26-35 and 56-67). In particular, this reference discloses SYLVALITE RE 100 XL, a pentaerythritol rosin ester (see column 11, lines 44-46; column 13, Table 3A; column 14, lines 26-34).

International Publication WO2015/013472 discloses a composition comprising the following components: A) an anhydride and/or carboxylic acid functionalized ethylene/alpha-olefin interpolymer comprising the following properties: i) a melt viscosity (177° C.) less than, or equal to, 50,000 cP; and ii) a density from 0.855 to 0.895 g/cc; B) a rosin-based tackifier; and wherein the tackifier is selected from the following: i) a partially hydrogenated glycerol ester; ii) a fully hydrogenated pentaerythritol ester; iii) a fully hydrogenated glycerol ester; iv) a non-hydrogenated ester with a Tg from 30° C. to 50° C.; or v) a combination thereof (see abstract and claim 1). Specific rosin tackifiers are listed in Table 2 (see page 27).

Additional adhesive compositions are disclosed in the following references: U.S. Pat. No. 6,319,979; U.S. Publication 2014/0037876; International Publication WO2018/176250.

However, as discussed above, there remains a need for adhesive compositions having improved adhesion performance in hygiene applications, and containing tackifiers derived from natural, renewable resources. This need has been met by the following invention.

### SUMMARY OF THE INVENTION

A composition comprising at least the following components:
a) an ethylene/alpha-olefin interpolymer that comprises the following properties:
   i) a melt index (I2)≤10 dg/min,
   ii) a density from 0.855 to 0.895 g/cc;

b) a partially hydrogenated rosin ester tackifier(s).

### DETAILED DESCRIPTION OF THE INVENTION

Compositions have been discovered that have good adhesion, and are well suited for adhering components of hygiene articles, such as, for example, diaper components. Also, these compositions contain partially hydrogenated rosin esters based on natural and renewable resources. It was discovered that these rosin esters have excellent compatibility with relatively high molecular weight (I2≤10 dg/min) ethylene/alpha-olefin interpolymers.

As discussed above, a composition is provided, comprising at least the following components:
a) an ethylene/alpha-olefin interpolymer that comprises the following properties:
   i) a melt index (I2)≤10 dg/min,
   ii) a density from 0.855 to 0.895 g/cc;
b) a partially hydrogenated rosin ester tackifier(s).

The above composition may comprise a combination of two or more embodiments, as described herein. Each component of the composition may comprise a combination of two or more embodiments, as described herein.

In one embodiment, or a combination of two or more embodiments, each described herein, the composition comprises ≥50.0 wt %, ≥55.0 wt %, or ≥60.0 wt %, or ≥62.0 wt %, or ≥65.0 wt %, or ≥67.0 wt %, or ≥70.0 wt %, or ≥75.0 wt % of the sum of components a and b, based on the weight of the composition. In one embodiment, or a combination of two or more embodiments, each described herein, the composition comprises ≤100.0 wt %, or ≤95.0 wt %, ≤90.0 wt %, or ≤85.0 wt %, or ≤80.0 wt % of the sum of components a and b, based on the weight of the composition.

In one embodiment, or a combination of two or more embodiments, each described herein, the ethylene/alpha-olefin interpolymer (component a) has a melt index (I2) ≥0.2, or ≥0.4, or ≥0.6, or ≥0.8, or ≥0.9, or ≥1.0 dg/min. In one embodiment, or a combination of two or more embodiments, each described herein, the ethylene/alpha-olefin interpolymer (component a) has a melt index (I2)≤9.0, or ≤8.0, or ≤7.0, or ≤6.0, or ≤5.0, or ≤4.0, or ≤3.0, or ≤2.0 dg/min.

In one embodiment, or a combination of two or more embodiments, each described herein, the partially hydrogenated rosin ester tackifier(s) (component b) is derived, in part, from an alcohol selected from the following: glycerol, pentaerythritol, triethylene glycol, and further from glycerol or pentaerythritol, and further from glycerol.

In one embodiment, or a combination of two or more embodiments, each described herein, the component b comprises ≥3.0 mol %, or ≥3.5 mol %, or ≥3.8 mol %, or ≥4.0 mol %, or ≥4.2 mol %, or ≥4.4 mol % of ester group carbon, based on total moles of carbon in the rosin ester, and determined by 13C NMR. In one embodiment, or a combination of two or more embodiments, each described herein, component b comprises ≤20.0 mol %, or ≤15.0 mol %, or ≤10.0 mol %, or ≤8.0 mol %, or ≤7.0 mol %, or ≤6.5 mol %, or ≤6.0 mol %, or ≤5.5 mol %, or ≤5.0 mol % of ester group carbon, based on total moles of carbon in the rosin ester, and determined by 13C NMR.

In one embodiment, or a combination of two or more embodiments, each described herein, component b comprises ≥60.0 mol %, or ≥62.0 mol %, or ≥65.0 mol %, or ≥67.0 mol %, or ≥68.0 mol %, or ≥70.0 mol %, or ≥72.0 mol %, or ≥74.0 mol %, or ≥75.0 mol %, or ≥76.0 mol %, or ≥77.0 mol %, or ≥78.0 mol % of aliphatic carbon, based on total moles of carbon in the rosin ester, and determined by 13C NMR. In one embodiment, or a combination of two or more embodiments, each described herein, component b comprises ≤90.0 mol %, or ≤88.0 mol %, or ≤86.0 mol %, or ≤84.0 mol %, or ≤82.0 mol %, or ≤80.0 mol % of aliphatic carbon, based on total moles of carbon in the rosin ester, and determined by 13C NMR.

In one embodiment, or a combination of two or more embodiments, each described herein, component b is a partially hydrogenated rosin ester tackifier.

In one embodiment, or a combination of two or more embodiments, each described herein, the ethylene/alpha-olefin interpolymer (component a) is an ethylene/alpha-olefin copolymer.

In one embodiment, or a combination of two or more embodiments, each described herein, the composition comprises at comprises ≥10.0 wt %, or ≥15.0 wt %, or ≥20.0 wt %, or ≥25.0 wt %, or ≥30.0 wt %, or ≥35.0 wt %, or ≥40.0 wt %, or ≥45.0 wt %, or ≥50.0 wt %, or ≥52.0 wt %, or ≥54.0 wt %, or ≥56.0 wt %, or ≥58.0 wt % of component b, based on the weight of the composition. In one embodiment, or a combination of two or more embodiments, each described herein, the composition comprises ≤70.0 wt %, or ≤69.0 wt %, or ≤68.0 wt %, or ≤67.0 wt %, or ≤66.0 wt %, or ≤65.0 wt %, or ≤64.0 wt %, or ≤63.0 wt %, or ≤62.0 wt %, or ≤61.0 wt %, or ≤60.0 wt % of component b, based on the weight of the composition.

In one embodiment, or a combination of two or more embodiments, each described herein, the weight ratio of component b to component a is ≥2.00, or ≥2.50, or ≥3.00, or ≥3.20, or ≥3.40, or ≥3.60, or ≥3.80, or ≥4.00, or ≥4.10, or ≥4.20, or ≥4.30. F2. In one embodiment, or a combination of two or more embodiments, each described herein, the weight ratio of component b to component a is ≤10.0, or ≤9.5, or ≤9.0, or ≤8.8, or ≤8.6, or ≤8.4, or ≤8.2, or ≤8.0.

In one embodiment, or a combination of two or more embodiments, each described herein, the composition further comprises an oil (component c).

In one embodiment, or a combination of two or more embodiments, each described herein, the weight ratio of component b to component c is ≥1.20, or ≥1.40, or ≥1.60, or ≥1.80, or ≥2.00, or ≥2.20, or ≥2.40, or ≥2.60, or ≥2.80, or ≥2.90, or ≥2.95. In one embodiment, or a combination of two or more embodiments, each described herein, the weight ratio of component b to component c is ≤5.00, or ≤4.50, or ≤4.00, or ≤3.80, or ≤3.60, or ≤3.50, or ≤3.40, or ≤3.30.

In one embodiment, or a combination of two or more embodiments, each described herein, the composition further comprises a second ethylene/alpha-olefin interpolymer (component d), and wherein the I2 of component d>the I2 of component a.

In one embodiment, or a combination of two or more embodiments, each described herein, the second ethylene/alpha-olefin interpolymer (component d) has a melt index (I2)≤2000, or ≤1800, or ≤1600, or ≤1400, or ≤1200, or ≤1100, or ≤1000 dg/min. In one embodiment, or a combination of two or more embodiments, each described herein, the second ethylene/alpha-olefin interpolymer (component d) has a melt index (I2) ≥200, or ≥250, or ≥300, or ≥350, or ≥400, or ≥420, or ≥440, or ≥460, or ≥480, or ≥500 dg/min.

In one embodiment, or a combination of two or more embodiments, each described herein, the second ethylene/alpha-olefin interpolymer (component d) has a density ≥0.856 g/cc, or ≥0.858 g/cc, or ≥0.860 g/cc, or ≥0.862 g/cc, or ≥0.864 g/cc, or ≥0.866 g/cc, or ≥0.868 g/cc, or ≥0.869 g/cc (1 cc=1 cm³). In one embodiment, or a combination of two or more embodiments, each described herein, the second ethylene/alpha-olefin interpolymer (component d) has a density ≤0.894 g/cc, or ≤0.892 g/cc, or ≤0.890 g/cc, or ≤0.888 g/cc, or ≤0.886 g/cc, or ≤0.884 g/cc, or ≤0.882 g/cc, or ≤0.880 g/cc, or ≤0.878 g/cc, or ≤0.876 g/cc, or ≤0.875 g/cc, or ≤0.874 g/cc.

In one embodiment, or a combination of two or more embodiments, each described herein, the second ethylene/alpha-olefin interpolymer (component d) is an ethylene/alpha-olefin copolymer.

In one embodiment, or a combination of two or more embodiments, each described herein, the weight ratio of component b to component dis ≥1.00, or ≥1.50, or ≥2.00, or ≥2.50, or ≥3.00, or ≥3.20, or ≥3.40, or ≥3.60, or ≥3.80, or ≥4.00, or ≥4.20, or ≥4.40, or ≥4.60. In one embodiment, or a combination of two or more embodiments, each described herein, the weight ratio of component b to component d is ≤7.00, or ≤6.50, or ≤6.00, or ≤5.80, or ≤5.50, or ≤5.20, or ≤5.00.

In one embodiment, or a combination of two or more embodiments, each described herein, the composition has a melt viscosity (150° C.) ≥1,000 mPa·s, or ≥1,500 mPa·s, or ≥2,000 mPa·s, or ≥2,500 mPa·s, or ≥3,000 mPa·s, or ≥3,500 mPa·s, or ≥4,000 mPa·s, or ≥4,200 mPa·s, or ≥4,500 mPa·s, or ≥4,700 mPa·s, or ≥5,000 mPa·s, or ≥5,200 mPa's, or 5,500 mPa·s, or ≥5,700 mPa·s, or ≥6,000 mPa·s, or ≥6,200 mPa·s, or ≥6,500 mPa·s, or ≥6,700 mPa·s, or ≥7,000 mPa·s. In one embodiment, or a combination of two or more embodiments, each described herein, the composition has a melt viscosity (150° C.)≤30,000 mPa·s, or ≤28,000 mPa·s, or ≤26,000 mPa's, or ≤24,000 mPa's, or ≤22,000 mPa's, or ≤20,000 mPa·s, or ≤18,000 mPa·s, or ≤16,000 mPa·s, or ≤14,000 mPa·s, or ≤12,000 mPa·s, or ≤10,000 mPa·s, or ≤9,500 mPa·s, or ≤9,000 mPa·s, or ≤8,500 mPa·s, or ≤8,000 mPa's, or ≤7,800 mPa·s, or ≤7,600 mPa·s, or ≤7,400 mPa·s, or ≤7,200 mPa·s.

In one embodiment, or a combination of two or more embodiments, each described herein, the composition has an average Peel Force at 5 gsm ≥1.50, or ≥1.60, or ≥1.80, or ≥2.00, or ≥2.20, or ≥2.40, or ≥2.50 N/25 mm. In one embodiment, or a combination of two or more embodiments, each described herein, the composition has an average Peel Force at 5 gsm≤8.0, or ≤7.0, or ≤6.0, or ≤5.0 N/25 mm.

In one embodiment, or a combination of two or more embodiments, each described herein, the composition is an adhesive, and further a hot melt adhesive or a pressure sensitive adhesive, and further a hot melt adhesive.

Also provided is an article comprising at least one component formed from the composition of any one embodiment, or a combination of two or more embodiments, each described herein. In one embodiment, or a combination of two or more embodiments, each described herein, the article is a hygiene article, and further a diaper, an incontinence pad, or a medical garment.

### Ethylene/Alpha-Olefin Interpolymers

The ethylene/alpha-olefin interpolymer comprises, in polymerize form, ethylene, and an alpha-olefin. Alpha-olefins include, but are not limited to, a C3-C20 alpha-olefins, further C3-C10 alpha-olefins, further C3-C8 alpha-olefins, such as propylene, 1-butene, 1-hexene, and 1-octene.

Such interpolymers also include ethylene/alpha-olefin/nonconjugated polyene interpolymers, which comprise, in polymerize form, ethylene, an alpha-olefin, and a nonconjugated polyene. Alpha-olefins include, but are not limited to, a C3-C20 alpha-olefins, further C3-C10 alpha-olefins, further C3-C8 alpha-olefins. In one embodiment, the interpolymer is an ethylene/propylene/nonconjugated polyene interpolymer, further a terpolymer, further an EPDM. Suitable examples of nonconjugated polyenes include the C4-C40 nonconjugated dienes. Nonconjugated dienes include, but are not limited to, 5-ethylidene-2-norbornene (ENB), 5-vinyl-2-norbornene (VNB), dicyclopentadiene, 1,4-hexadiene, or 7-methyl-1,6-octadiene, and further from ENB, VNB, dicyclopentadiene or 1,4-hexadiene, and further from ENB or VNB, and further ENB.

### Partially Hydrogenated Rosin Ester Tackifier

Tackifiers are known in the art, and may be solids, semi-solids, or liquids at room temperature. The term “hydrogenated rosin ester tackifier,” and similar terms, refer to a rosin resin (for example, gum rosin, wood rosin, tall oil rosin, etc., and combinations thereof) that has been esterified and fully hydrogenated. The term “partially hydrogenated rosin ester tackifier,” and similar terms, refer to a rosin resin (for example, gum rosin, wood rosin, tall oil rosin, etc., and combinations thereof) that has been esterified and partially hydrogenated. Typically, the rosin is esterified and then hydrogenated.

Hydrogenation is a reduction reaction that results in the addition of hydrogen to a molecule, polymer, etc., and typically refers to the addition of pairs of hydrogen atoms to alkene and/or alkyne groups present in the molecule, polymer, etc. Hydrogenation is typically run under catalytic conditions, such as, for example, in the presence of nickel, palladium or platinum. A hydrogenation may result in a complete or full hydrogenation, in which all of the unsaturated bonds (for example, alkene and/or alkyne) are saturated upon the addition of hydrogen; or may result in a partial hydrogenation, in which some unsaturated bonds remain after the hydrogenation.

A “rosin ester” refers to an ester, typically prepared via a reaction between a rosin acid and an alcohol. The resulting rosin ester is hydrogenated, to form a hydrogenated or partially hydrogenated rosin ester tackifier. It is understood that, as an ester, the rosin ester contains at least one ester group with oxygen atoms. The rosin ester excludes tackifier composed only of hydrogen and carbon atoms. A “polyol” is an alcohol containing at least two hydroxyl groups (—OH). Polyols included, but are not limited to, glycerol, pentaerythritol, or triethylene glycol.

A “rosin acid” is a mixture of resin acids, which are carboxylic acids. As shown above, nonlimiting examples of suitable rosins include gum rosin, wood rosin, tall oil rosin, and combinations thereof. Nonlimiting examples of suitable resin acids include abietic acid, neoabietic acid, dehydroabietic acid, palustric acid, levopimaric acid, pimaric acid, isopimaric acid, and combinations thereof. Some of these acids are present in two or more isomeric forms.

Suitable partially hydrogenated rosin ester tackifiers include, but are not limited to, STAYBELITE ESTER 5-E RESIN (Synthomer). In regard to these rosin esters, the term “aliphatic carbon” refers to a carbon atom covalently bonded to hydrogen or another carbon via a single bond. The aliphatic carbon level pertains to those carbon atoms in the final rosin ester (i.e., the polymerized, esterified, and hydrogenated polymeric structure) that are saturated and bonded to hydrogen or another carbon via a single bond. Aliphatic carbon excludes carbon bonded to a heteroatom, such as oxygen. The term “ester group carbon” refers to the carbon atom of an ester group. An “ester group” is a moiety with the following

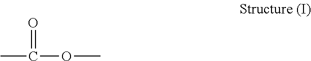

Structure (I). An “ester group carbon” is the carbon of the Structure (I) ester group, where the carbon atom is bonded to one oxygen atom with a double bond and to a second oxygen atom with a single bond.

### Oils and Other Additives

Non-limiting examples of oils include olefin oligomers, low molecular weight polyolefins such as liquid polybutene, phthalates, mineral oils such as naphthenic, paraffinic and hydrotreated paraffinic process oils (for example, CATENEX T 145 oil), or hydrogenated (white) oils (e.g., KAYDOL oil), vegetable and animal oils and their derivatives, petroleum derived oils, and combinations thereof. In one embodiment, or a combination of two or more embodiments, each described herein, the oil is selected from mineral oils, hydrogenated oils, hydrotreated oils, or petroleum derived oils. In one embodiment, or a combination of two or more embodiments, each described herein, the oil is selected from hydrotreated paraffinic process oils.

An inventive composition may include one or more additives. In an embodiment, the composition comprises at least one antioxidant. An antioxidant protects the composition from degradation caused by reaction with oxygen, induced by such things as heat, light, or residual catalyst present in a commercial material. Suitable antioxidants include, for example, those commercially available from BASF, such as, IRGANOX 1010, IRGANOX B225, IRGANOX 1076 and IRGANOX 1726. These antioxidants, which act as radical scavengers, may be used alone, or in combination with other antioxidants, such as phosphite antioxidants, like IRGAFOS 168, also available from BASF. In an embodiment, the composition comprises from 0.01 wt %, or 0.02 wt %, or 0.04 wt %, or 0.06 wt %, or 0.08 wt %, or 0.10 wt %, or 0.20 wt % to 0.30 wt %, or 0.40 wt %, or 0.50 wt %, or 0.60 wt %, or 0.80 wt % or 1.00 wt % of at least one antioxidant. Weight percent is based on total weight of the composition.

### Definitions

Unless stated to the contrary, implicit from the context, or customary in the art, all parts and percentages are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers, such as one or more antioxidants.

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to a random interpolymer that comprises, in polymerized form, 50 wt % or a majority weight percent of ethylene (based on the weight of the interpolymer), and an alpha-olefin.

The term, “ethylene/alpha-olefin copolymer,” as used herein, refers to a random copolymer that comprises, in polymerized form, 50 wt % or a majority amount of ethylene monomer (based on the weight of the copolymer), and an alpha-olefin, as the only two monomer types.

The phrase “a majority weight percent,” as used herein, in reference to a polymer (or interpolymer, or terpolymer or copolymer), refers to the amount of monomer present in the greatest amount in the polymer.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Composition Features

A] A composition comprising at least the following components:
a) an ethylene/alpha-olefin interpolymer that comprises the following properties:
   i) a melt index (I2)≤10 dg/min,
   ii) a density from 0.855 to 0.895 g/cc;
b) a partially hydrogenated rosin ester tackifier(s).
   B] The composition of A] above, wherein the ethylene/alpha-olefin interpolymer (component a) has a melt index (I2) ≥0.2, or ≥0.4, or ≥0.6, or ≥0.8, or ≥0.9, or ≥1.0 dg/min.
   C] The composition of A] or B] above, wherein the ethylene/alpha-olefin interpolymer (component a) has a melt index (I2)≤9.0, or ≤8.0, or ≤7.0, or ≤6.0, or ≤5.0, or ≤4.0, or ≤3.0, or ≤2.0 dg/min.
   D] The composition of any one of A]-C] (A] through C]) above, wherein the ethylene/alpha-olefin interpolymer (component a) has a density ≥0.856 g/cc, or ≥0.858 g/cc, or ≥0.860 g/cc, or ≥0.862 g/cc, or ≥0.864 g/cc, or ≥0.866 g/cc, or ≥0.868 g/cc, or ≥0.869 g/cc (1 cc=1 cm³).
   E] The composition of any one of A]-D] above, wherein the ethylene/alpha-olefin interpolymer (component a) has a density ≤0.894 g/cc, or ≤0.892 g/cc, or ≤0.890 g/cc, or ≤0.888 g/cc, or ≤0.886 g/cc, or ≤0.884 g/cc, or ≤0.882 g/cc, or ≤0.880 g/cc, or ≤0.878 g/cc, or ≤0.876 g/cc, or ≤0.874 g/cc, or ≤0.872 g/cc, or ≤0.871 g/cc.
   F] The composition of any one of A]-E] above, wherein the ethylene/alpha-olefin interpolymer (component a) has a peak melting temperature (Tm) ≥40.0° C., or ≥45.0° C., or ≥50.0° C., or ≥52.0° C., or ≥54.0° C., or ≥56.0° C., or ≥58.0° C., as determined by DSC.
   G] The composition of any one of A]-F] above, wherein the ethylene/alpha-olefin interpolymer (component a) has a peak melting temperature ≤80.0° C., or ≤75.0° C., or ≤70.0° C., or ≤68.0° C., or ≤66.0° C., or ≤64.0° C., or ≤62.0° C., or ≤61.0° C., or ≤60.0° C., as determined by DSC.
   H] The composition of any one of A]-G] above, wherein the ethylene/alpha-olefin interpolymer (component a) has a glass transition temperature (Tg) ≥−70.0° C., or ≥−65.0° C., or ≥−60.0° C., or ≥−55.0° C., as determined by DSC.
   I] The composition of any one of A]-H] above, wherein the ethylene/alpha-olefin interpolymer (component a) has a glass transition temperature (Tg)≤−30.0° C., or ≤−35.0° C., or ≤−40.0° C., or ≤−45.0° C., or ≤−50.0° C., as determined by DSC.
   J] The composition of any one of A]-I] above, wherein the ethylene/alpha-olefin interpolymer (component a) has a crystallization temperature (Tc) ≥20.0° C., or ≥25.0° C., or ≥30.0° C., or ≥35.0° C., or ≥40.0° C., or ≥42.0° C., as determined by DSC.
   K] The composition of any one of A]-J] above, wherein the ethylene/alpha-olefin interpolymer (component a) has a crystallization temperature (Tc)≤60.0° C., or ≤55.0° C., or ≤50.0° C., or ≤48.0° C., or ≤46.0° C., as determined by DSC.
   L] The composition of any one of A]-K] above, wherein the ethylene/alpha-olefin interpolymer (component a) has a Mooney Viscosity (ML 1+4, 121° C.) ≥2.0, or ≥4.0, or ≥5.0, or ≥6.0, or ≥7.0, or ≥7.5, or ≥8.0.
   M] The composition of any one of A]-L] above, wherein the ethylene/alpha-olefin interpolymer (component a) has a Mooney Viscosity (ML 1+4, 121° C.)≤40, or ≤35, or ≤30, or ≤25.
   N] The composition of any one of A]-M] above, wherein the alpha-olefin of the ethylene/alpha-olefin interpolymer (component a) is a C3-C20 alpha-olefin, and further a C3-C10 alpha-olefin, and further a C3-C8 alpha-olefin.
   O] The composition of any one of A]-N] above, wherein the alpha-olefin of the ethylene/alpha-olefin interpolymer (component a) is selected from propylene, 1-butene, 1-pentene, 1-hexene or 1-octene, and further propylene, 1-butene or 1-octene, and further 1-butene or 1-octene, and further 1-octene.
   P] The composition of any one of A]-O] above, wherein the ethylene/alpha-olefin interpolymer (component a) is an ethylene/alpha-olefin copolymer.
   Q] The composition of any one of A]-P] above, wherein the ethylene/alpha-olefin interpolymer (component a) is selected from the following: an ethylene/propylene copolymer, an ethylene/butene copolymer, or an ethylene/octene copolymer, and further an ethylene/butene copolymer, or an ethylene/octene copolymer, and further an ethylene/octene copolymer.
   R] The composition of any one of A]-Q] above, wherein the partially hydrogenated rosin ester tackifier(s) (component b) is derived, in part, from an alcohol selected from the following: glycerol, pentaerythritol, or triethylene glycol, and further from glycerol or pentaerythritol, and further from glycerol.
   S] The composition of any one of A]-R] above, wherein component b comprises ≥3.0 mol %, or ≥3.5 mol %, or ≥3.8 mol %, or ≥4.0 mol %, or ≥4.2 mol %, or ≥4.4 mol % of ester group carbon, based on total moles of carbon in the rosin ester, and determined by 13C NMR.
   T] The composition of any one of A]-S] above, wherein component b comprises ≤20.0 mol %, or ≤15.0 mol %, or ≤10.0 mol %, or ≤8.0 mol %, or ≤7.0 mol %, or ≤6.5 mol %, or ≤6.0 mol %, or ≤5.5 mol %, or ≤5.0 mol % of ester group carbon, based on total moles of carbon in the rosin ester, and determined by 13C NMR.
   U] The composition of any one of A]-T] above, wherein component b comprises ≥60.0 mol %, or ≥62.0 mol %, or ≥65.0 mol %, or ≥68.0 mol %, or ≥70.0 mol %, or ≥72.0 mol %, or ≥74.0 mol %, or ≥75.0 mol %, or ≥76.0 mol %, or ≥77.0 mol %, or ≥78.0 mol % of aliphatic carbon, based on total moles of carbon in the rosin ester, and determined by 13C NMR.
   V] The composition of any one of A]-U] above, wherein the component b comprises ≤90.0 mol %, or ≤88.0 mol %, or ≤86.0 mol %, or ≤84.0 mol %, or ≤82.0 mol %, or ≤80.0 mol % of aliphatic carbon, based on total moles of carbon in the rosin ester, and determined by 13C NMR.
   W] The composition of any one of A]-V] above, wherein component b has an initial melting temperature ≥50° C., or ≥60° C., or ≥70° C., or ≥80° C., or ≥85° C., as determined by DSC.
   X] The composition of any one of A]-W] above, wherein component b has a final melting temperature ≤100° C., or ≤97° C., or ≤95° C., or ≤92° C., or ≤90° C., as determined by DSC.
   Y] The composition of any one of A]-X] above, wherein the composition comprises ≥50.0 wt %, ≥55.0 wt %, or ≥60.0 wt %, or ≥62.0 wt %, or ≥65.0 wt %, or ≥67.0 wt %, or ≥70.0 wt %, or ≥75.0 wt % of the sum of components a and b, based on the weight of the composition.
   Z] The composition of any one of A]-Y] above, wherein the composition comprises ≤100.0 wt %, or ≤95.0 wt %, ≤90.0 wt %, or ≤85.0 wt %, or ≤80.0 wt % of the sum of components a and b, based on the weight of the composition.
   A2] The composition of any one of A]-Z] above, wherein the composition comprises at comprises ≥2.0 wt %, or ≥3.0 wt %, or ≥4.0 wt %, or ≥5.0 wt %, or ≥5.5 wt %, or ≥6.0 wt %, or ≥6.5 wt %, or ≥7.0 wt %, or ≥7.5 wt % of component a, based on the weight of the composition.
   B2] The composition of any one of A]-A2] above, wherein the composition comprises ≤50.0 wt %, or ≤45.0 wt %, or ≤40.0 wt %, or ≤35.0 wt %, or ≤30.0 wt %, or ≤25.0 wt %, or ≤22.0 wt %, or ≤20.0 wt %, or ≤18.0 wt %, or ≤16.0 wt % of component a, based on the weight of the composition.
   C2] The composition of any one of A]-B2] above, wherein the composition comprises at comprises ≥10.0 wt %, or ≥15.0 wt %, or ≥20.0 wt %, or ≥25.0 wt %, or ≥30.0 wt %, or ≥35.0 wt %, or ≥40.0 wt %, or ≥45.0 wt %, or ≥50.0 wt %, or ≥52.0 wt %, or ≥54.0 wt %, or ≥56.0 wt %, or ≥58.0 wt % of component b, based on the weight of the composition.
   D2] The composition of any one of A]-C2] above, wherein the composition comprises ≤70.0 wt %, or ≤69.0 wt %, or ≤68.0 wt %, or ≤67.0 wt %, or ≤66.0 wt %, or ≤65.0 wt %, or ≤64.0 wt %, or ≤63.0 wt %, or ≤62.0 wt %, or ≤61.0 wt %, or ≤60.0 wt % of component b, based on the weight of the composition.
   E2] The composition of any one of A]-D2] above, wherein the weight ratio of component b to component a is ≥2.00, or ≥2.50, or ≥3.00, or ≥3.20, or ≥3.40, or ≥3.60, or ≥3.80, or ≥4.00, or ≥4.10, or ≥4.20, or ≥4.30.
   F2] The composition of any one of A]-E2] above, wherein the weight ratio of component b to component a is ≤10.0, or ≤9.5, or ≤9.0, or ≤8.8, or ≤8.6, or ≤8.4, or ≤8.2, or ≤8.0.
   G2] The composition of any one of A]-F2] above, wherein the composition further comprises an oil (component c). Further the oil is selected from mineral oils, hydrogenated oils, hydrotreated oils, or petroleum derived oils, and further from hydrotreated oils, and further from hydrotreated paraffinic process oils.
   H2] The composition of G2] above, wherein the composition comprises ≥2.0 wt %, or ≥5.0 wt %, or ≥10.0 wt %, or ≥12.0 wt %, or ≥14.0 wt %, or ≥16.0 wt %, or ≥18.0 wt % of the oil (component c), based on the weight of the composition.
   [2] The composition of G2] or H2] above, wherein the composition comprises ≤40.0 wt %, or ≤35.0 wt %, or ≤30.0 wt %, or ≤28.0 wt %, or ≤26.0 wt %, or ≤24.0 wt %, or ≤22.0 wt %, or ≤20.0 wt % of the oil, based on the weight of the composition.
   J2] The composition of any one of G2]-I2] above, wherein the weight ratio of component b to component c is ≥1.20, or ≥1.40, or ≥1.60, or ≥1.80, or ≥2.00, or ≥2.20, or ≥2.40, or ≥2.60, or ≥2.80, or ≥2.90, or ≥2.95.
   K2] The composition of any one of G2]-J2] above, wherein the weight ratio of component b to component c is ≤5.00, or ≤4.50, or ≤4.00, or ≤3.80, or ≤3.60, or ≤3.50, or ≤3.40, or ≤3.30.
   L2] The composition of any one of G2]K2] above, wherein the weight ratio of component c to component a is ≥1.00, or ≥1.05, or ≥1.10, or ≥1.15, or ≥1.20, or ≥1.25, or ≥1.30.
   M2] The composition of any one of G2]-L2] above, wherein the weight ratio of component c to component a is ≤4.00, or ≤3.80, or ≤3.60, or ≤3.40, or ≤3.20, or ≤3.00, or ≤2.90, or ≤2.80, or ≤2.70.
   N2] The composition of any one of G2]-M2] above, wherein the composition comprises ≥70.0 wt %, ≥75.0 wt %, or ≥80.0 wt %, or ≥82.0 wt %, or ≥84.0 wt %, or ≥86.0 wt %, or ≥87.0 wt % of the sum of components a, b and c, based on the weight of the composition.
   O2] The composition of any one of G2]-N2] above, wherein the composition comprises ≤100.0 wt %, or ≤99.8 wt %, ≤99.6 wt %, or ≤99.5 wt % of the sum of components a, b and c, based on the weight of the composition.
   P2] The composition of any one of A]-O2] above, wherein the composition further comprises a second ethylene/alpha-olefin interpolymer (component d), and wherein the I2 of component d>the I2 of component a.
   Q2] The composition of P2] above, wherein the second ethylene/alpha-olefin interpolymer (component d) has a melt index (I2)≤2000, or ≤1800, or ≤1600, or ≤1400, or ≤1200, or ≤1100, or ≤1000 dg/min.
   R2] The composition of P2] or Q2] above, wherein the second ethylene/alpha-olefin interpolymer (component d) has a melt index (I2) ≥200, or ≥250, or ≥300, or ≥350, or ≥400, or ≥ or ≥420, or ≥440, or ≥460, or ≥480, or ≥500 dg/min.
   S2] The composition of any one of P2]-R2] above, wherein the second ethylene/alpha-olefin interpolymer (component d) has a density ≥0.856 g/cc, or ≥0.858 g/cc, or ≥0.860 g/cc, or ≥0.862 g/cc, or ≥0.864 g/cc, or ≥0.866 g/cc, or ≥0.868 g/cc, or ≥0.869 g/cc (1 cc=1 cm³).
   T2] The composition of any one of P2]-S2] above, wherein the second ethylene/alpha-olefin interpolymer (component d) has a density ≤0.894 g/cc, or ≤0.892 g/cc, or ≤0.890 g/cc, or ≤0.888 g/cc, or ≤0.886 g/cc, or ≤0.884 g/cc, or ≤0.882 g/cc, or ≤0.880 g/cc, or ≤0.878 g/cc, or ≤0.876 g/cc, or ≤0.875 g/cc, or ≤0.874 g/cc.
   U2] The composition of any one of P2]-T2] above, wherein the second ethylene/alpha-olefin interpolymer (component d) has a melt viscosity (177° C.) ≥4,000 mPa·s, or ≥4,500 mPa·s, or ≥5,000 mPa·s, or ≥5,500 mPa·s, or ≥6,000 mPa·s, or ≥6,500 mPa·s, or ≥7,000 mPa·s, or ≥7,200 mPa·s, or ≥7,400 mPa·s, or ≥7,600 mPa·s, or ≥7,800 mPa·s, or ≥8,000 mPa's, or 8,100 mPa·s, or ≥8,150 mPa·s.
   V2] The composition of any one of P2]-U2] above, wherein the second ethylene/alpha-olefin interpolymer (component d) has a viscosity (177° C.)≤50,000 mPa·s, or ≤45,000 mPa·s, or ≤40,000 mPa's, or ≤35,000 mPa·s, or ≤30,000 mPa·s, or ≤28,000 mPa·s, or ≤26,000 mPa·s, or ≤24,000 mPa's, or ≤22,000 mPa·s, or ≤20,000 mPa·s, or ≤19,000 mPa·s, or ≤18,500 mPa·s, or ≤18,000 mPa's, or ≤17,500 mPa·s.
   W2] The composition of any one of P2]-V2] above, wherein the second ethylene/alpha-olefin interpolymer (component d) has a peak melting point (Tm) ≥50.0° C., or ≥55.0° C., or ≥60.0° C., or ≥62.0° C., or ≥64.0° C., or ≥66.0° C., or ≥67.0° C., as determined by DSC.
   X2] The composition of any one of P2]-W2] above, wherein the second ethylene/alpha-olefin interpolymer (component d) has a peak melting point (Tm)≤90.0° C., or ≤85.0° C., or ≤80.0° C., or ≤78.0° C., or ≤76.0° C., or ≤74.0° C., or ≤72.0° C., or ≤71.0° C., as determined by DSC.
   Y2] The composition of any one of P2]-X2] above, wherein the second ethylene/alpha-olefin interpolymer (component d) has a glass transition temperature (Tg)≤−40.0° C., or ≤−45.0° C., or ≤−50.0° C., or ≤−51.0° C., or ≤−52.0° C., or ≤−53.0° C., or ≤−54.0° C., as determined by DSC.
   Z2] The composition of any one of P2]-Y2] above, wherein the second ethylene/alpha-olefin interpolymer (component d) has a glass transition temperature (Tg) ≥−80.0° C., or ≥−75.0° C., or ≥−70.0° C., or ≥−68.0° C., or ≥−66.0° C., or ≥−64.0° C., or ≥−62.0° C., or ≥−61.0° C., or ≥−60.0° C., or ≥−59.0° C. as determined by DSC.
   A3] The composition of any one of P2]-Z2] above, wherein the alpha-olefin of the second ethylene/alpha-olefin interpolymer (component d) is a C3-C20 alpha-olefin, and further a C3-C10 alpha-olefin, and further a C3-C8 alpha-olefin.
   B3] The composition of any one of P2]-A3] above, wherein the alpha-olefin of the second ethylene/alpha-olefin interpolymer (component d) is selected from propylene, 1-butene, 1-pentene, 1-hexene or 1-octene, and further propylene, 1-butene or 1-octene, and further 1-butene or 1-octene, and further 1-octene.
   C3] The composition of any one of P2]-B3] above, wherein the second ethylene/alpha-olefin interpolymer (component d) is an ethylene/alpha-olefin copolymer.
   D3] The composition of any one of P2]-C3] above, wherein the second ethylene/alpha-olefin interpolymer (component d) is selected from the following: an ethylene/propylene copolymer, an ethylene/butene copolymer, or an ethylene/octene copolymer, and further an ethylene/butene copolymer, or an ethylene/octene copolymer, and further an ethylene/octene copolymer.
   E3] The composition of any one of P2]-D3] above, wherein the composition comprises ≥5.0 wt %, or ≥6.0 wt %, or ≥7.0 wt %, or ≥8.0 wt %, or ≥9.0 wt %, or ≥10.0 wt % of the second ethylene/alpha-olefin interpolymer (component d), based on the weight of the composition.
   F3] The composition of any one of P2]-E3] above, wherein the composition comprises ≤60.0 wt %, or ≤50.0 wt %, ≤40.0 wt %, or ≤35.0 wt %, or ≤30.0 wt %, or ≤25.0 wt %, or ≤20.0 wt %, or ≤18.0 wt %, or ≤16.0 wt %, or ≤14.0 wt % of the second ethylene/alpha-olefin interpolymer (component d), based on the weight of the composition.
   G3] The composition of any one of P2]-F3] above, wherein the weight ratio of component b to component dis ≥1.00, or ≥1.50, or ≥2.00, or ≥2.50, or ≥3.00, or ≥3.20, or ≥3.40, or ≥3.60, or ≥3.80, or ≥4.00, or ≥4.20, or ≥4.40, or ≥4.60.
   H3] The composition of any one of P2]-G3] above, wherein the weight ratio of component b to component d is ≤7.00, or ≤6.50, or ≤6.00, or ≤5.80, or ≤5.50, or ≤5.20, or ≤5.00.
   I3] The composition of any one of P2]-H3] above, wherein the weight ratio of component d to component a is ≥1.00, or ≥1.05, or ≥1.10, or ≥1.15, or ≥1.20, or ≥1.25, or ≥1.30.
   J3] The composition of any one of P2]-I3] above, wherein the weight ratio of component d to component a is ≤3.00, or ≤2.80, or ≤2.60, or ≤2.40, or ≤2.20, or ≤2.00, or ≤1.90, or ≤1.80, or ≤1.70.
   K3] The composition of any one of P2]-J3] above, wherein the composition comprises ≥60.0 wt %, ≥65.0 wt %, or ≥70.0 wt %, or ≥72.0 wt %, or ≥74.0 wt %, or ≥76.0 wt %, or ≥78.0 wt % of the sum of components a, b and d, based on the weight of the composition.
   L3] The composition of any one of P2]-K3] above, wherein the composition comprises ≤95.0 wt %, or ≤90.0 wt %, or ≤85.0 wt %, or ≤80.0 wt % of the sum of components a, b and d, based on the weight of the composition.
   M3] The composition of any one of P2]-L3] above, wherein the composition comprises ≥80.0 wt %, ≥85.0 wt %, or ≥90.0 wt %, or ≥92.0 wt %, or ≥94.0 wt %, or ≥96.0 wt %, or ≥98.0 wt % of the sum of components a, b, c and d, based on the weight of the composition. N3] The composition of any one of P2]-M3] above, wherein the composition comprises ≤100.0 wt %, or ≤99.9 wt %, or ≤99.8 wt %, or ≤99.6 wt %, or ≤99.4 wt %, or ≤99.2 wt %, or ≤99.0 wt % of the sum of components a, b, c and d, based on the weight of the composition.
   O3] The composition of any one of A]-N3] above, wherein the composition further comprises a thermoplastic polymer, different from the ethylene/alpha-olefin interpolymer (component a), in one or more features, such as monomer types, monomer distributions, and/or monomer amounts, density, melt index (I2), Mn, Mw, Mz, MWD, Mooney Viscosity (ML 1+4, 121° C.), V0.1, V100, RR, or any combination thereof, and further in one or more features, such as monomer types, monomer distributions, and/or monomer amounts, density, melt index (I2), Mn, Mw, MWD, or any combination thereof. In a further embodiment, the thermoplastic polymer, also differs from the second ethylene/alpha-olefin interpolymer (component d), in one or more features, such as monomer types, monomer distributions, and/or monomer amounts, density, melt index (I2), Mn, Mw, Mz, MWD, melt viscosity (177° C.), V0.1, V100, RR, or any combination thereof, and further in one or more features, such as monomer types, monomer distributions, and/or monomer amounts, density, melt index (I2), Mn, Mw, MWD, or any combination thereof.
   P3] The composition of any one of A]-O3] above, wherein the composition has a melt viscosity (150° C.) ≥1,000 mPa·s, or ≥1,500 mPa·s, or ≥2,000 mPa·s, or ≥2,500 mPa·s, or ≥3,000 mPa·s, or ≥3,500 mPa·s, or ≥4,000 mPa·s, or ≥4,200 mPa·s, or ≥4,500 mPa's, or ≥4,700 mPa·s, or ≥5,000 mPa·s, or ≥5,200 mPa·s, or 5,500 mPa·s, or ≥5,700 mPa·s, or ≥6,000 mPa·s, or ≥6,200 mPa·s, or ≥6,500 mPa·s, or ≥6,700 mPa·s, or ≥7,000 mPa·s.
   Q3] The composition of any one of A]-P3] above, wherein the composition has a melt viscosity (150° C.)≤30,000 mPa·s, or ≤28,000 mPa·s, or ≤26,000 mPa·s, or ≤24,000 mPa·s, or ≤22,000 mPa·s, or ≤20,000 mPa·s, or ≤18,000 mPa·s, or ≤16,000 mPa·s, or ≤14,000 mPa·s, or ≤12,000 mPa·s, or ≤10,000 mPa·s, or ≤9,500 mPa·s, or ≤9,000 mPa·s, or ≤8,500 mPa·s, or ≤8,000 mPa·s, or ≤7,800 mPa's, or ≤7,600 mPa's, or ≤7,400 mPa·s.
   R3] The composition of any one of A]-Q3] above, wherein the composition has an average Peel Force at 2 gsm ≥1.50, or ≥1.60, or ≥1.70, or ≥1.80, or ≥1.90 N/25 mm.
   S3] The composition of any one of A]-R3] above, wherein the composition has an average Peel Force at 2 gsm≤8.0, or ≤7.0, or ≤6.0, or ≤5.0 N/25 mm.
   T3] The composition of any one of A]-S3] above, wherein the composition has an average Peel Force at 3 gsm ≥1.50, or ≥1.60, or ≥1.80, or ≥1.90, or ≥2.00, or ≥2.10 N/25 mm.
   U3] The composition of any one of A]-T3] above, wherein the composition has an average Peel Force at 3 gsm≤8.0, or ≤7.0, or ≤6.0, or ≤5.0 N/25 mm.
   V3] The composition of any one of A]-U3] above, wherein the composition has an average Peel Force at 5 gsm ≥1.50, or ≥1.60, or ≥1.80, or ≥2.00, or ≥2.20, or ≥2.40, or ≥2.50 N/25 mm.
   W3] The composition of any one of A]-V3] above, wherein the composition has an average Peel Force at 5 gsm≤8.0, or ≤7.0, or ≤6.0, or ≤5.0 N/25 mm.
   X3] The composition of any one of A]-W3] above, wherein the ethylene/alpha-olefin interpolymer (component a) has a molecular weight distribution (MWD) ≥1.2, or ≥1.4, or ≥1.6, or ≥1.8, or ≥2.0, and/or ≤5.0, or ≤4.0, or ≤3.5, or ≤3.0, or ≤2.8, or ≤2.6, or ≤2.4, or ≤2.2.
   Y3] The composition of any one of P2]-X3] above, wherein the second ethylene/alpha-olefin interpolymer (component d) has a molecular weight distribution (MWD) ≥1.2, or ≥1.4, or ≥1.6, or ≥1.8, or ≥2.0, and/or ≤5.0, or ≤4.0, or ≤3.5, or ≤3.0, or ≤2.8, or ≤2.6, or ≤2.4, or ≤2.2.
   Z3] The composition of any one of A]-Y3] above, wherein the composition is an adhesive, and further a hot melt adhesive or a pressure sensitive adhesive, and further a hot melt adhesive.
   A4] An article comprising at least one component formed from the composition of any one of A]-Z3] above.
   B4] The article of A4] above, wherein the article is a hygiene article, and further a diaper, an incontinence pad, or a medical garment.
   C4] A method of forming an adhesive, said method comprising mixing the composition of any one of A]-Y3] above.
   D4] The method of C4] above, where the adhesive is a hot melt adhesive or a pressure sensitive adhesive, and further a hot melt adhesive.

### Test Methods

### 13C NMR Experimental Procedure for the Rosin Ester

13C NMR can be used to measure aliphatic carbon content, oxygenates content, aromatic carbon content, unsaturated carbon content, ester group content, aldehyde group content, and ketone group content as follows.

Sample Preparation (Rosin Ester)—Each sample was prepared in tetrachloroethane-d2, by adding approximately “2.7 g of tetrachloroethane-d2 containing 0.025 M Cr(AcAc)₃” to “0.20-0.30 g of sample” in a NORELL 1001-7 (10 mm) NMR tube. The sample was dissolved and homogenized by heating the tube and its contents to 150° C., using a heating block and a heat gun. Each sample was visually inspected to ensure homogeneity.

Data Acquisition Parameters (Rosin Ester)—The data was collected using a Bruker 400 MHz spectrometer, equipped with a Bruker Dual DUL high-temperature CryoProbe. The data was acquired using 160 scans per data file, a 6 sec pulse repetition delay, 90 degree flip angles, and an inverse gated decoupling with a sample temperature of 120° C. The acquisitions were carried out using a spectral width of 25,000 Hz and a file size of 32K data points. The integral ranges used for quantitation of aliphatic carbon content, oxygenates content, aromatic carbon content, unsaturated carbon content, ester group content, aldehyde group content, and ketone group content are listed below in Table A. The mole percentage of each carbon group can be determined from the peak of interest.

TABLE A
¹³C NMR Integral Ranges Used for Quantitation

| Component | Peak(s) Integrated |
|---|---|
| Aldehylde/Ketone Carbonyl | about 200 to 202 ppm |
| Ester Carbonyl | about 175 to 182 ppm |
| Unsaturated/Aromatic Carbon | about 100 to 150 ppm |
| Oxygenates (—O—CH₍ₙ₎—) | about 61 to 71 ppm |
| (likely, the “non-carbonyl | |
| carbon” connected to the divalent | |
| oxygen of an ester group, or the | |
| carbon of an ether group) | |
| Aliphatic Carbon | about 10 to 61 ppm |

### Viscosity of the Polymer

The melt viscosity of each polymer (8-10 grams) is measured according to ASTM D3236, using a Brookfield Viscometer, model LVDV-1 Prime with a Thermosel. The viscosity is measured at 177° C., using spindle SC4-31.

### Melt Index

The melt index MI (or I2) of an ethylene-based polymer is measured in accordance with ASTM D-1238, condition 190° C./2.16 kg.

### Density

The density of a polymer is measured by preparing the polymer sample according to ASTM D 1928, and then measuring the density according to ASTM D792, Method B, within one hour of sample pressing.

### Differential Scanning Calorimetry (DSC)

Differential Scanning calorimetry (DSC) is used to measure Tm, Tc, Tg and crystallinity in ethylene-based (PE) polymer samples. Each sample (0.5 g) is compression molded into a film, at 25000 psi, 190° C., from 10 to 15 seconds. About 5 to 8 mg of film sample is weighed and placed in a DSC pan. The lid is crimped on the pan to ensure a closed atmosphere. The sample pan is placed in a DSC cell, and then heated, at a rate of approximately 10° C./min, to a temperature of 180° C. for PE. The sample is kept at this temperature for three minutes. Then the sample is cooled at a rate of 10° C./min to −90° C. for PE, and kept isothermally at that temperature for three minutes. The sample is next heated at a rate of 10° C./min, until complete melting (second heat). Unless otherwise stated, melting point (Tm, peak) and the glass transition temperature (Tg) of each polymer sample are determined from the second heat curve, and the crystallization temperature (Tc) is determined from the first cooling curve. The Tg and the respective peak temperatures for the Tm and the Tc are recorded. The percent crystallinity can be calculated by dividing the heat of fusion (Hf), determined from the second heat curve, by a theoretical heat of fusion of 292 J/g for PE, and multiplying this quantity by 100 (for example, % cryst.=(Hf/292 J/g)×100 (for PE)).

### Gel Permeation Chromatography

The chromatographic system consists of a PolymerChar GPC-IR (Valencia, Spain) high temperature GPC chromatograph, equipped with an internal IR5 infra-red detector (IR5). The autosampler oven compartment is set at 160° Celsius, and the column compartment is set at 150° Celsius. The columns are four AGILENT “Mixed A” 30 cm, 20-micron linear mixed-bed columns. The chromatographic solvent is 1,2,4-trichlorobenzene, which contained 200 ppm of butylated hydroxytoluene (BHT). The solvent source is nitrogen sparged. The injection volume is 200 microliters, and the flow rate is 1.0 milliliters/minute.

Calibration of the GPC column set is performed with 21 narrow molecular weight distribution polystyrene standards, with molecular weights ranging from 580 to 8,400,000, and which are arranged in six “cocktail” mixtures, with at least a decade of separation between individual molecular weights. The standards are purchased from Agilent Technologies. The polystyrene standards are prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards are dissolved at 80° Celsius, with gentle agitation, for 30 minutes. The polystyrene standard peak molecular weights are converted to polyethylene molecular weights using Equation 1 (as described in Williams and Ward, J. Polym. Sci., Polym. Let., 6, 621 (1968)): M_{polyethylene}=A×(M_{polystyrene})^{B} (EQ1), where M is the molecular weight, A has a value of 0.4315 and B is equal to 1.0.

A fifth order polynomial is used to fit the respective polyethylene equivalent calibration points. A small adjustment to A (from approximately 0.375 to 0.445) is made to correct for column resolution and band-broadening effects, such that linear homopolymer polyethylene standard is obtained at 120,000 Mw.

The total plate count of the GPC column set is performed with decane (prepared at “0.04 g in 50 milliliters” of TCB, and dissolved for 20 minutes with gentle agitation). The plate count (Equation 2) and symmetry (Equation 3) are measured on a 200 microliter injection according to the following equations:

$$Plate Count = 5.54 * {( \frac{( {RV}_{Peak Max}}{Peak Width at \frac{1}{2} height} )}^{2} , \qquad ( EQ2 )$$

where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - {RV}_{Peak Max} )}{( {RV}_{Peak max} - Front Peak {RV}_{one tength height} )} , \qquad ( EQ3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples are prepared in a semi-automatic manner with the PolymerChar “Instrument Control” Software, wherein the samples are weight-targeted at “2 mg/ml,” and the solvent (contained 200 ppm BHT) is added to a pre nitrogen-sparged, septa-capped vial, via the PolymerChar high temperature autosampler. The samples are dissolved for two hours at 160° Celsius under “low speed” shaking.

The calculations of Mn_{(GPC)}, Mw_{(GPC)}, and Mz_{(GPC)} are based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{{polyethylene}_{i}} )} , \qquad ( EQ4 )$$

$${Mw}_{( GPC )} = \frac{{\sum }^{i} ( {IR}_{i} * {M}_{{polyethylene}_{i}} )}{{\sum }^{i} {IR}_{i}} , and \qquad ( EQ5 )$$

$${Mz}_{( GPC )} = \frac{{\sum }^{i} ( {IR}_{i} * {M}_{{polyethylene}_{i}^{2}} )}{{\sum }^{i} ( {IR}_{i} * {M}_{{polyethylene}_{i}} )} . \qquad ( EQ6 )$$

In order to monitor the deviations over time, a flowrate marker (decane) is introduced into each sample, via a micropump controlled with the PolymerChar GPC-IR system. This flowrate marker (FM) is used to linearly correct the pump flowrate (Flowrate (nominal)) for each sample, by RV alignment of the respective decane peak within the sample (RV(FM Sample)), to that of the decane peak within the narrow standards calibration (RV(FM Calibrated)). Any changes in the time of the decane marker peak are then assumed to be related to a linear-shift in flowrate (Flowrate (effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system, based on a flow marker peak, the effective flowrate (with respect to the narrow standards calibration) is calculated from Equation 7: Flowrate (effective)=Flowrate (nominal)*(RV(FM Calibrated)/RV(FM Sample)) (EQ7). Processing of the flow marker peak is done via the PolymerChar GPCOne™ software. Acceptable flowrate correction is such that the effective flowrate should be within +/−0.7% of the nominal flowrate.

### Experimental

Commercial reagents are listed in Table 1.

TABLE 1
Commercial Reagents

| Component | Description | Source |
|---|---|---|
| ENGAGE 8200 | Ethylene/octene copolymer (5.0 MI, 0.870 g/cc, Tm = | Dow |
| | 59.0° C., Tg = −53.0° C., Tc = 44.0 C. | |
| ENGAGE 8100 | Ethylene/octene copolymer (1.0 MI, 0.870 g/cc, Tm = | Dow |
| | 60.0° C., Tg = −52.0° C., Tc = 45.0 C. | |
| AFFINITY GA 1950 | Ethylene/octene copolymer (η = 17,500 mPa · s, | Dow |
| | 490-500 MI*, 0.874 g/cc, Tm = 70.0° C., Tg = −56.1° C.) | |
| AFFINITY GA 1000R | MAH functionalized Ethylene/octene copolymer | Dow |
| | (η = 13,000 mPa · s, 630-660 MI*, 0.878 g/cc, | |
| | Tm = 68.0° C., Tg = −58.0° C.) | |
| AFFINITY GA 1900 | Ethylene/octene copolymer (η = 8,200 mPa · s, | Dow |
| | 950-1000 MI*, 0.870 g/cc, Tm = 67.8° C., Tg = −57.8° C.) | |
| REGALITE R1090 | Hydrocarbon Resin | Eastman Chemical |
| REGALITE R1090 | Hydrocarbon Resin | Synthomer |
| STAYBELITE ESTER 5-E | Glycerol Ester of a Partially Hydrogenated Rosin | Synthomer |
| RESIN** | | |
| RESIDHERE ES-100 S*** | Resin and Rosin Acids, Esters with Glycerol | Socer |
| CATENEX T145 | Hydrotreated Paraffinic Oil | Shell |
| IRGANOX 1010 | Antioxidant | BASF |

*Note, the equation “MI = [3.6126(10^{(log(η)-6.6928)/-1.1363)} − 9.3185], where η (cP or mPa · s) = melt viscosity at 350° F. (177° C.)” can be used to calculate melt index (2.16 kg, 190° C.) for the AFFINITY Grades 1900, 1950 and 1000R. MI = I2
**Staybelite Ester 5E has 79.7 mol % aliphatic carbon, 5.1 mol % ester group carbon. Each mol % is based on total moles of carbon in the rosin ester, and determined by 13C NMR.
***Residhere ES 100 S has 69.1 mol % aliphatic carbon, 4.9 mol % ester group carbon. Each mol % is based on total moles of carbon in the rosin ester, and determined by 13C NMR.

### Formulated Composition (Hot Melt Adhesive) Preparation

Each formulated composition was prepared using a laboratory type adhesive mixer (Model Z Blade mixer LUK) that consisted of the following: a mixing blade powered by a motor, an oil-heating unit, a temperature and rpm control unit, and a mixing chamber of about 0.25 L in volume. Each composition was prepared by first weighing the appropriate amount of each component, in order to make a “200 g batch” of sample. Components were added to the pre-heated (at 180° C.) mixing chamber, until melted, and in the following sequence: first, polymer or polymers; second, oil; and third, tackifier plus the IRGANOX 1010. These components were gently mixed at 180° C. and 5 rpm, to limit the heat or shear degradation. Next, two mixing stages were employed as follows: three minutes at 20 rpm, followed by ten minutes at 66 rpm. The set temperature for the regulator was 180° C. during all of the mixing steps. Each composition was visually inspected for consistency, and, when thoroughly mixed, was poured out onto a recipient substrate. The composition was covered by release paper. Formulated compositions are shown in Tables 2A, 2B and 2C.

TABLE 2A
Composition (wt %)

| | Comp. A | Comp. B | Comp. C |
|---|---|---|---|
| ENGAGE 8100 | | | 7.5 |
| ENGAGE 8200 | 15 | 15 | |
| AFFINITY 1950 | | | 12.5 |
| AFFINITY 1000R | | | |
| AFFINITY 1900 | | | |
| REGALITE R1090* | 64.5 | | 59.5 |
| RESIDHERE 100 S | | 64.5 | |
| CATENEX T145 | 20 | 20 | 20 |
| IRGANOX 1010 | 0.5 | 0.5 | 0.5 |
| Weight Parts | 100 | 100 | 100 |

*REGALITE R1090 from Eastman.

TABLE 2B
Composition (wt %)

| | Comp. D | Comp. E | Comp. F |
|---|---|---|---|
| AFFINITY 1000R | | 59.5 | 59.5 |
| AFFINITY 1900 | 64.5 | | |
| REGALITE R1090* | 30 | 30 | |
| RESIDHERE 100 S | | | 30 |
| CATENEX T145 | 5 | 10 | 10 |
| IRGANOX 1010 | 0.5 | 0.5 | 0.5 |
| Weight Parts | 100 | 100 | 100 |

*REGALITE R1090 from Eastman.

TABLE 2C
Composition (wt %)

| | Comp. | Ex. | Comp. | Ex. | Comp. | Comp. |
|---|---|---|---|---|---|---|
| | G | 1 | H | 2 | I | J |
| Engage 8100 | 15 | 15 | 7.5 | 7.5 | | |
| Affinity 1950 | | | 12.5 | 12.5 | | |
| Affinity 1900 | | | | | 64.5 | 64.5 |
| REGALITE R1090* | 64.5 | | 59.5 | | 30 | |
| STABELITE | | 64.5 | | 59.5 | | 30 |
| ESTER 5-E RESIN | | | | | | |
| CATENEX T145 | 20 | 20 | 20 | 20 | 5 | 5 |
| IRGANOX 1010 | 0.5 | 0.5 | 0.5 | 0.5 | 0.5 | 0.5 |
| Weight Parts | 100 | 100 | 100 | 100 | 100 | 100 |

*REGALITE R1090 from Synthomer.

### Melt Viscosities of Formulated Compositions

The melt viscosity of each above formulated composition was measured at 150° C., in accordance with ASTM D-3236, using a Brookfield RV-DV-II-Pro Viscometer and spindle SC4-27. The heating device was set for this temperature (150° C.), and the spindle was positioned into the heating device, and equilibrated at this temperature. Next, the composition (9.5 grams) was weighted in a properly disposable sample chamber, and introduced into the heating device over a period of five minutes and/or until melted. The spindle was then positioned inside the melt for around ten minutes. Once the composition and Brookfield components reached the desired temperature (150° C.), the spindle speed was set at 20-50 rpm, in order to produce a torque value in the range of 70% to 90%. At intervals of three minutes, the viscosity value was read, in order to monitor the viscosity behavior during the experiment. The melt viscosity value was reported after 30 minutes (viscosity equilibrated). Results are shown in Table 3A, Table 3B and Table 3C.

### Laminate Production for Peel Test Study

Each laminate was prepared using a Nordson/JHT lab Coater a Nordson True-Coat Slot Die. A hydrophobic polypropylene (PP) non-woven (12 gsm) from Fitesa was used along with a breathable back sheet (16 gsm) from Clopay MicroPro FPS K-16M. The formulated composition (adhesive) was applied to the non-woven. The melting tank, transfer hose and melt applicators were all set at 150° C. Composition add-on weights were 5, 3 and 2 gsm (grams/square meter). The line speed was set to 50 m/min, and the pump was set at 25, 15, 10 RPM, and, for a coating weight of 5 gsm, 3 gsm and 2 gsm, respectively.

A “200 mm (l)×150 mm (w)” bonded sheet was produced for each composition. Within each sheet, a bond area of ‘150 mm×150 mm” was produced. Each bonded sheet was cut along its length (l), to produce five test sample, each having a dimension of “200 mm (l)×‘25+0.5 mm’ (w),” and a bond area of “150 mm×‘25+0.5 mm’.” The bond area ran the entire width of each test sample, and ran a distance of 150 mm, from one end of the test sample, along the length of the test sample. This left the remaining length (50 mm) of the test sample unbound, or a non-bonded area of “50 mm×‘25+0.5 mm’” remained. The nonwoven sheet and back sheet of the unbounded area were each clamped in a respective pneumatic clamp for the T-Peel test below.

### T-Peel Test Study

Each test was carried out at a Zwick Z010 Universal Testing Machine. The test sample was cut from the laminate produced from the coating line, as discussed above. Each laminate sample (25+0.5 mm wide) was fixed in the machine via pneumatic clamps. The distance between the lower and upper clamp was fixed at 30 mm, at the beginning of the test. The peel force of each sample was measured according to the ISO 11339, at a pull rate of 300 mm/min. The data was recorded automatically. A minimum of five laminate test samples were measured per formulated composition, and the average Peel Force reported. Results are shown in Table 3A, Table 3B and Table 3C.

As seen in Tables 3A, 3B and 3C, the inventive compositions had excellent Peel Force values and contained a bio-based tackifier. The inventive compositions are well suited for use in hygiene articles, such as diapers, pads or medical garments. The comparative compositions E, F, J showed inferior peel performance; for example, with less than “1.40 N/25 mm” at 3 gsm coating weight. Comparative B was visually incompatible and brittle, and not suitable for coating or further testing. Comparative compositions A, C, D, G, H and I each contained the undesired synthetic tackifier, as did composition E. These comparative compositions are not preferred, because of the increase in the amount of carbon dioxide release into the atmosphere during the synthesis of the tackifier.

TABLE 3A
Viscosity and Adhesion Results

| | Comp. | Comp. | Comp. |
|---|---|---|---|
| | A | B | C |
| ENGAGE 8100 | | | 7.5 |
| ENGAGE 8200 | 15 | 15 | |
| AFFINITY 1950 | | | 12.5 |
| AFFINITY 1000R | | | |
| AFFINITY 1900 | | | |
| REGALITE R1090 | 64.5 | | 59.5 |
| RESIDHERE ES-100S | | 64.5 | |
| CATENEX T145 | 20 | 20 | 20 |
| IRGANOX 1010 | 0.5 | 0.5 | 0.5 |
| Melt (Brookfield) Viscosity | 4892 | In-comp.* | 4675 |
| at 150° C. (mPa · s) | | | |
| Average Peel Force 2 gsm (N/25 mm) | 2.9 | — | 2.5 |
| Average Peel Force 3 gsm (N/25 mm) | 4.8 | — | 3.1 |
| Average Peel Force 5 gsm (N/25 mm) | 4.8 | — | 4.1 |
| Bio-based Tackifier | No | Yes | No |

*In-comp. = In-compatible (phase separation), and unable to process.

TABLE 3B
Viscosity and Adhesion Results

| | Comp. D | Comp. E | Comp. F |
|---|---|---|---|
| AFFINITY 1000R | | 59.5 | 59.5 |
| AFFINITY 1900 | 64.5 | | |
| REGALITE R1090 | 30 | 30 | |
| RESIDHERE ES-100S | | | 30 |
| CATENEX T145 | 5 | 10 | 10 |
| IRGANOX 1010 | 0.5 | 0.5 | 0.5 |
| Melt (Brookfield) Viscosity | 5433 | 8250 | 3262 |
| at 150° C. (mPa · s) | | | |
| Average Peel Force 2 gsm | 1.5 | 1.0 | 0.3 |
| (N/25 mm) | | | |
| Average Peel Force 3 gsm | 1.9 | 1.1 | 0.5 |
| (N/25 mm) | | | |
| Average Peel Force 5 gsm | 2.5 | 1.7 | 0.6 |
| (N/25 mm) | | | |
| Bio-based Tackifier | No | No | Yes |

TABLE 3C
Viscosity and Adhesion

| | Comp. G | Ex. 1 | Comp. H | Ex. 2 | Comp. I | Comp. J |
|---|---|---|---|---|---|---|
| ENGAGE 8100 | 15 | 15 | 7.5 | 7.5 | | |
| AFFINITY 1950 | | | 12.5 | 12.5 | | |
| AFFINITY 1900 | | | | | 64.5 | 64.5 |
| REGALITE R1090* | 64.5 | | 59.5 | | 30 | |
| STAYBELITE ESTER | | 64.5 | | 59.5 | | 30 |
| 5-E RESIN | | | | | | |
| CATENEX T145 | 20 | 20 | 20 | 20 | 5 | 5 |
| IRGANOX 1010 | 0.5 | 0.5 | 0.5 | 0.5 | 0.5 | 0.5 |
| Melt (Brookfield) | 18,000 | 25,650 | 4117 | 7175 | 4783 | 5183 |
| Viscosity at 150° C. | | | | | | |
| (mPa · s) | | | | | | |
| Average Peel Force | 2.1 | 1.6 | 2.4 | 2.1 | 1.1 | 0.4 |
| 2 gsm (N/25 mm) | | | | | | |
| Average Peel Force | 2.4 | 1.5 | 2.7 | 2.0 | 1.5 | 0.4 |
| 3 gsm (N/25 mm) | | | | | | |
| Average Peel Force | 1.9 | 1.6 | 3.5 | 2.5 | 2.0 | 0.2 |
| 5 gsm (N/25 mm) | | | | | | |
| Bio-based Tackifier | No | Yes | No | Yes | No | Yes |

1. A composition comprising at least the following components:
a) an ethylene/alpha-olefin interpolymer that comprises the following properties:
i) a melt index (I2)≤10 dg/min,
ii) a density from 0.855 to 0.895 g/cc;
b) a partially hydrogenated rosin ester tackifier(s).

2. The composition of claim 1, wherein the composition comprises from 50.0 wt % to 100.0 wt % of the sum of components a and b, based on the weight of the composition.

3. The composition of claim 1, wherein the ethylene/alpha-olefin interpolymer (component a) has a melt index (I2) ≥0.2 dg/min.

4. The composition of claim 1, wherein component b is derived, in part, from an alcohol selected from the following: glycerol, pentaerythritol, or triethylene glycol.

5. The composition of claim 1, wherein component b comprises from 3.0 mol % to 20.0 mol % of ester group carbon, based on total moles of carbon in the rosin ester, and determined by 13C NMR.

6. The composition of claim 1, wherein component b comprises from 60.0 mol % to 90.0 mol % of aliphatic carbon, based on total moles of carbon in the rosin ester, and determined by 13C NMR.

7. The composition of claim 1, wherein the ethylene/alpha-olefin interpolymer (component a) is an ethylene/alpha-olefin copolymer.

8. The composition of claim 1, wherein the composition comprises from 10.0 wt % to 70.0 wt % of component b, based on the weight of the composition.

9. The composition of claim 1, wherein the weight ratio of component b to component a is from 2.00 to 10.0.

10. The composition of claim 1, wherein the composition further comprises an oil (component c).

11. The composition of claim 1, wherein the weight ratio of component b to component c is from 1.20 to 5.00.

12. The composition of claim 1, wherein the composition further comprises a second ethylene/alpha-olefin interpolymer (component d), and wherein the I2 of component d>the I2 of component a.

13. The composition of claim 12, wherein the second ethylene/alpha-olefin interpolymer (component d) has a melt index (I2) from 200 to 2000 dg/min.

14. The composition of claim 12, wherein the second ethylene/alpha-olefin interpolymer (component d) has a density from 0.856 g/cc to 0.894 g/cc.

15. The composition of claim 12, wherein the second ethylene/alpha-olefin interpolymer (component d) is an ethylene/alpha-olefin copolymer.

16. The composition of claim 12, wherein the weight ratio of component b to component d is from 1.00 to 7.00.

17. The composition of claim 1, wherein the composition has a melt viscosity (150° C.) from 1,000 mPa·s to 30,000 mPa·s.

18. The composition of claim 1, wherein the composition has an average Peel Force at 5 gsm from 1.50 to 8.00 N/25 mm.

19. The composition of claim 1, wherein the composition is an adhesive.

20. An article comprising at least one component formed from the composition of claim 1.
